(19) United States
(12) Patent Application Publication
(10) Pub. No.: US 2025/0344294 A1
(43) Pub. Date: Nov. 6, 2025

(54) IMMERSION WATER HEATER

(71) Applicant: Xuhang LIU, Zhuhai City (CN)

(72) Inventor: Xuhang LIU, Zhuhai City (CN)

(21) Appl. No.: 19/271,757

(22) Filed: Jul. 16, 2025

(51) Int. Cl. H05B 3/80; H05B 3/02

(52) U.S. Cl. CPC H05B 3/80; H05B 3/02; H05B 2203/021

(57) ABSTRACT

The present invention discloses an immersion water heater, which comprises a housing, a water heater, and a control device. The lower end of the housing is provided with two probe-type low-water cutoffs, which are respectively located on the front and rear sides of the housing. The connecting end of the water heater is connected to the lower end of the housing, and the free end of the water heater extends in a direction away from the housing. The control device is electrically connected to the water heater and the probe-type low-water cutoffs. When both probe-type low-water cutoffs are submerged below the liquid surface, the control device activates the water heater; when either of the probe-type low-water cutoffs is out of the liquid surface, the control device deactivates the water heater.

### TECHNICAL FIELD

The present invention relates to the field of heating devices, particularly to an immersion water heater.

### BACKGROUND OF THE INVENTION

Water heaters, as a type of home appliance for rapidly heating water, have gained widespread application in daily life. Among them, instant water heaters, known for their compact size and convenient use, are especially favored by consumers.

Currently, most instant water heaters on the market are made based on the principle of the thermal effect of electric current. When electric current passes through the internal resistance wire, heat is generated to warm the water around the resistance wire. However, there are certain issues with existing instant water heaters. During use, if the water is boiled dry and the heater continues to operate, or if the heater is tilted with only part of the resistance wire submerged in water, the exposed part of the resistance wire will rapidly increase in temperature. On one hand, this can damage the product and reduce its lifespan. On the other hand, it may also ignite the product or surrounding items, potentially burning the user, thus posing a threat to the user's life and property safety. Some instant water heater products are equipped with a temperature sensor that cuts off power to the heater when the temperature exceeds a preset value due to dry burning. However, this solution also has its drawbacks. By the time the temperature exceeds the preset value, the product has already been dry burning for a while, which can easily lead to product aging and may also cause items to catch fire, resulting in a fire hazard. As a popular product with a strong market demand, instant water heaters currently fail to meet users' safety requirements, causing difficulties for users in selecting and using such products.

To address these issues, the present invention provides an immersion water heater that effectively solves the aforementioned problems. It features a simple structure with two probe-type low water cutoffs. When either of the two low-water probes detects a low water level, the circuit of the heating element is immediately disconnected to prevent dry burning. Moreover, the two probe-type low water cutoffs are located on opposite sides of the product, which can also prevent dry burning when the product is in a tilted position. This design extends the product's lifespan, avoids the risk of fire, and allows users to use the immersion water heater with confidence.

### SUMMARY OF THE INVENTION

To overcome the deficiencies of the existing technology, the present invention provides an immersion water heater with a simple structure. When either of the two probe-type low-water cutoffs detects a low water level, the circuit of the water heater is immediately disconnected to prevent dry burning. Moreover, the two probe-type low-water cutoffs are located on opposite sides of the product, which can also prevent dry burning when the product is in a tilted position. This design extends the product's lifespan and avoids the risk of fire.

The technical solution adopted by the present invention to solve its technical problem is as follows:

An immersion water heater comprising:

A housing, the lower end of which is provided with two probe-type low-water cutoffs, the two probe-type low-water cutoffs being respectively located on the front and rear sides of the housing;

A water heater, the connecting end of which is connected to the lower end of the housing, the free end of the water heater extending in a direction away from the housing;

The control device, which is electrically connected to the water heater and the probe-type low-water cutoffs. When both probe-type low-water cutoffs are submerged below the liquid surface, the control device activates the water heater. When either of the probe-type low-water cutoffs is out of the liquid surface, the control device deactivates the water heater.

As an improvement to the present invention, the water heater has a front surface, a rear surface, a left surface, and a right surface. The front surface passes through the front end of the water heater and is parallel to the front reference plane. The rear surface passes through the rear end of the water heater and is parallel to the front reference plane. The left surface passes through the left end of the water heater and is parallel to the right reference plane. The right surface passes through the right end of the water heater and is parallel to the right reference plane. A heating area a is formed between the front surface, the rear surface, the left surface, and the right surface. The probe-type low-water cutoffs are located outside the water heater.

As an improvement to the present invention, one probe-type low-water cutoff is located in front of the front surface and to the left of the left surface, and the other probe-type low-water cutoff is located behind the rear surface and to the right of the right surface; or one probe-type low-water cutoff is located in front of the front surface and to the right of the right surface, and the other probe-type low-water cutoff is located behind the rear surface and to the left of the left surface.

As an improvement to the present invention, the two probe-type low-water cutoffs are respectively an emitting probe and a receiving probe. The emitting probe is used to emit a pulse signal, and the receiving probe is used to receive the pulse signal. When both probe-type low-water cutoffs are submerged below the liquid surface and the receiving probe receives the pulse signal, the control device activates the water heater. When either of the probe-type low-water cutoffs is out of the liquid surface and the receiving probe fails to receive the pulse signal, the control device deactivates the water heater.

As an improvement to the present invention, the control device comprises the control module, a water level sensor, and the heating module. The water level sensor and the heating module are electrically connected to the control module. When both probe-type low-water cutoffs are submerged below the liquid surface, the water level sensor sends a first signal to the control module, and the control module controls the heating module to connect the circuit of the water heater. When either of the probe-type low-water cutoffs is out of the liquid surface, the water level sensor sends a second signal to the control module, and the control module controls the heating module to disconnect the circuit of the water heater.

As an improvement to the present invention, the water level sensor includes a pulse emission unit, a pulse reception unit, and a signal output unit. The pulse emission unit emits a pulse signal through the emitting probe. The TSET1 pin of the pulse reception unit is electrically connected to the TSET1 pin of the signal output unit. The signal output unit outputs the first signal to the control module through the RB6/SHUIWEI1 pin and outputs the second signal to the control module through the RB5/SHUIWEI2 pin.

As an improvement to the present invention, the water level sensor further includes an operational amplifier unit that is electrically connected to the signal output unit, with the VEF pin of the operational amplifier unit being electrically connected to the VEF pin of the signal output unit.

As an improvement to the present invention, it further comprises a protective cover that is connected to the lower end of the housing and covers the water heater. The protective cover is provided with a plurality of through holes to allow liquid to pass through.

As an improvement to the present invention, the lower end of the housing is provided with a connection slot, into which the edge of the protective cover is inserted.

As an improvement to the present invention, at least part of the through holes are located on the lower surface of the protective cover.

As an improvement to the present invention, the housing is further provided with a temperature sensor that is electrically connected to the control device. The temperature sensor is used to detect the liquid temperature.

As an improvement to the present invention, the control device is further electrically connected to a display screen. The display screen is used to display the liquid temperature value detected by the temperature sensor.

As an improvement to the present invention, the protective cover is cylindrical, and the projections of the protective cover and the housing on the top reference plane are both oval.

As an improvement to the present invention, the control device further comprises a control button that is used to allow the user to output a control signal to the control device by pressing the control button.

As an improvement to the present invention, the water heater is a metal column, both ends of which are connected to the lower end of the housing. The middle part of the metal column is bent and folded to form a free end in the shape of an oval.

As an improvement to the present invention, the duty cycle of the pulse signal emitted by the emitting probe is 1%.

As an improvement to the present invention, the lower end of the housing has a downwardly extending insertion part that is inserted into the opening of the protective cover.

As an improvement to the present invention, the outer edge of the end of the insertion part is provided with a guide bevel.

As an improvement to the present invention, the housing is further provided with a protective part. A protective slot is formed between the protective part and the outer surface of the housing, within which at least part of the probe-type low-water cutoffs is located.

As an improvement to the present invention, the control device further comprises an indicator light that is used to display the working state of the product.

The beneficial effects of the present invention are as follows: With the above-mentioned structural arrangements, when using the product, place it in a water container so that water submerges the water heater and the two probe-type low-water cutoffs. Turn on the switch. When both probe-type low-water cutoffs are below the liquid surface, the control device activates the water heater, which can quickly heat the water for the user's convenience. However, when the product is tilted or the liquid level drops, and at least one of the two probe-type low-water cutoffs is out of the liquid surface, the control device deactivates the water heater to prevent it from dry burning, thereby extending the product's lifespan, avoiding the risk of fire, and ensuring user safety. Moreover, since the two probe-type low-water cutoffs are located on the front and rear sides of the housing, when the product is tilted and placed in the water container, if both probe-type low-water cutoffs are below the liquid surface, it can ensure that the water heater is below the liquid surface. Preferably, there can be three or more probe-type low-water cutoffs. When any one of the probe-type low-water cutoffs is out of the liquid surface, the control device deactivates the water heater. The probe-type low-water cutoffs are evenly distributed at the lower end of the housing. When all the probe-type low-water cutoffs are below the liquid surface, it can ensure that the water heater is basically below the liquid surface to prevent dry burning.

### BRIEF DESCRIPTION OF DRAWINGS

To more clearly illustrate the technical solutions in the embodiments of the present invention, a brief introduction to the accompanying drawings used in the description of the embodiments will be provided below. The drawings described below are merely some embodiments of the present invention. For those of ordinary skill in the art, other drawings can also be obtained based on these drawings without making inventive efforts.

The present invention will be further described below in conjunction with the drawings and embodiments.

FIG. 1 is a perspective view of the immersion water heater according to the present invention from one angle;

FIG. 2 is a perspective view of the immersion water heater according to the present invention from another angle;

FIG. 3 is an exploded view of the immersion water heater according to the present invention from one angle;

FIG. 4 is an exploded view of the immersion water heater according to the present invention from another angle;

FIG. 5 is a bottom view of a part of the immersion water heater according to the present invention;

FIG. 6 is a schematic view of the immersion water heater according to the present invention in use;

FIG. 7 is a block diagram of the immersion water heater according to the present invention;

FIG. 8 is a block diagram of the water level sensor of the immersion water heater according to the present invention;

FIG. 9 is a partial circuit diagram of the first embodiment of the water level sensor of the immersion water heater according to the present invention;

FIG. 10 is another partial circuit diagram of the first embodiment of the water level sensor of the immersion water heater according to the present invention;

FIG. 11 is a partial circuit diagram of the second embodiment of the water level sensor of the immersion water heater according to the present invention;

FIG. 12 is another partial circuit diagram of the second embodiment of the water level sensor of the immersion water heater according to the present invention.

### DETAILED DESCRIPTION OF THE INVENTION

To make the above-mentioned objectives, features, and advantages of this application clearer and easier to understand, the specific implementation methods of this application will be described in detail below in conjunction with the accompanying drawings. Many specific details are set forth in the following description to fully understand this application. However, this application can be implemented in many ways other than those described here. Technical personnel in this field can make similar improvements without departing from the connotation of this application. Therefore, this application is not limited to the specific implementation examples disclosed below.

In the description of this application, it should be understood that if terms such as “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” “counterclockwise,” “axial,” “radial,” “circumferential,” etc., appear, these terms indicate directions or positional relationships based on the directions or positional relationships shown in the accompanying drawings. They are used only for the convenience of describing this application and simplifying the description, rather than indicating or implying that the device or element must have a specific direction or be constructed and operated in a specific direction. Therefore, these terms should not be understood as limitations to this application.

In addition, if terms such as “first” and “second” appear, these terms are used only for descriptive purposes and should not be understood as indicating or implying relative importance or implicitly indicating the number of technical features indicated. Therefore, features defined by “first” and “second” may explicitly or implicitly include at least one such feature. In the description of this application, if the term “multiple” appears, it means at least two, such as two, three, etc., unless otherwise specifically limited.

In this application, unless otherwise clearly stipulated and defined, if terms such as “install,” “connect,” “connect,” “fix,” etc., appear, these terms should be understood broadly. For example, they may refer to fixed connections, detachable connections, or integrated structures; they may refer to mechanical connections or electrical connections; they may refer to direct connections or indirect connections through intermediate media, or they may refer to the interconnection or interaction between two components, unless otherwise specifically defined. For ordinary technical personnel in this field, the specific meanings of the above terms in this application can be understood according to the specific situation.

In this application, unless otherwise clearly stipulated and defined, if there is a description such as the first feature being “above” or “below” the second feature, it means that the first and second features may be in direct contact, or they may be in indirect contact through an intermediate medium. Moreover, the first feature being “above,” “over,” or “on top of” the second feature may mean that the first feature is directly above or diagonally above the second feature, or it may simply indicate that the first feature is at a higher horizontal level than the second feature. The first feature being “below,” “under,” or “beneath” the second feature may mean that the first feature is directly below or diagonally below the second feature, or it may simply indicate that the first feature is at a lower horizontal level than the second feature.

It should be noted that if a component is referred to as being “fixed on” or “disposed on” another component, it can be directly on the other component or there may be an intervening component. If a component is considered to be “connected” to another component, it can be directly connected to the other component or there may be an intervening component. If they exist, the terms “vertical,” “horizontal,” “up,” “down,” “left,” “right,” and similar expressions used in the present application are for illustrative purposes only and do not represent the only implementation.

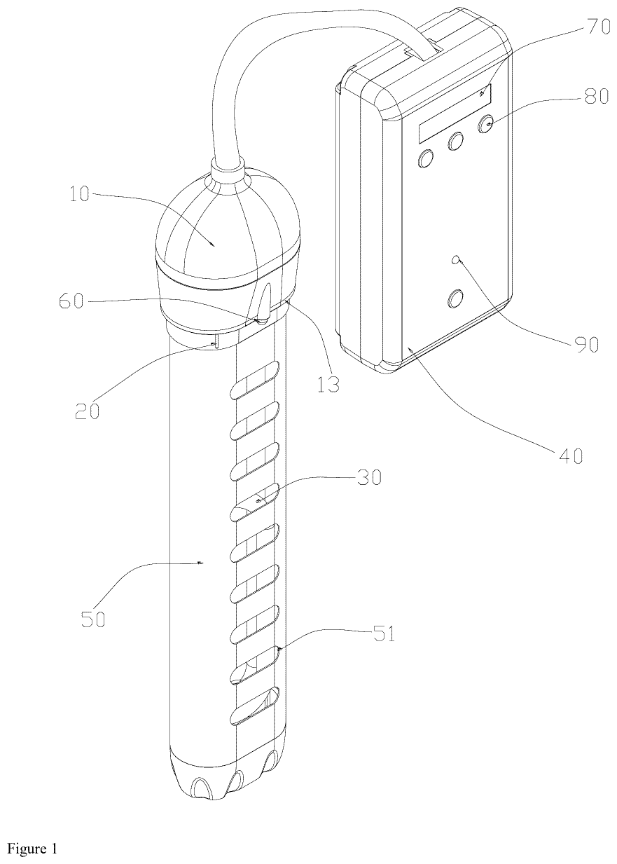

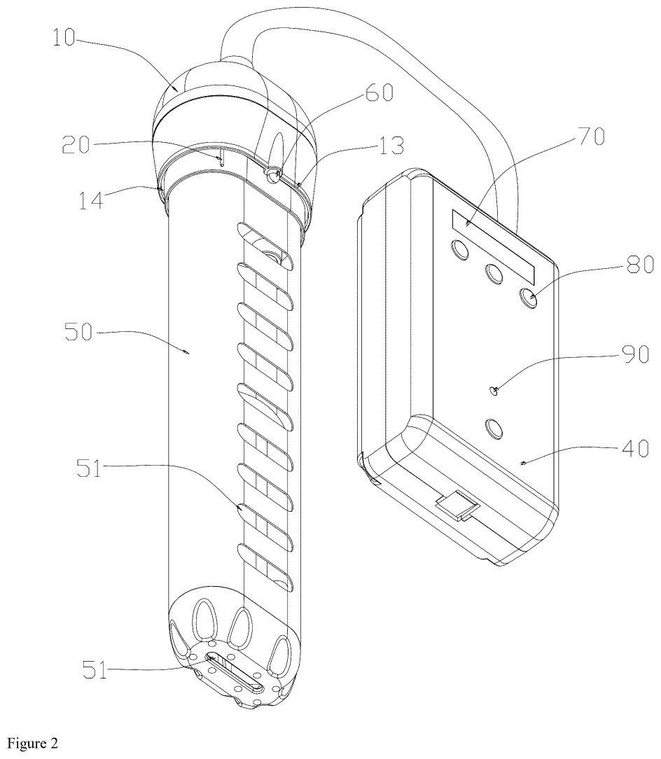

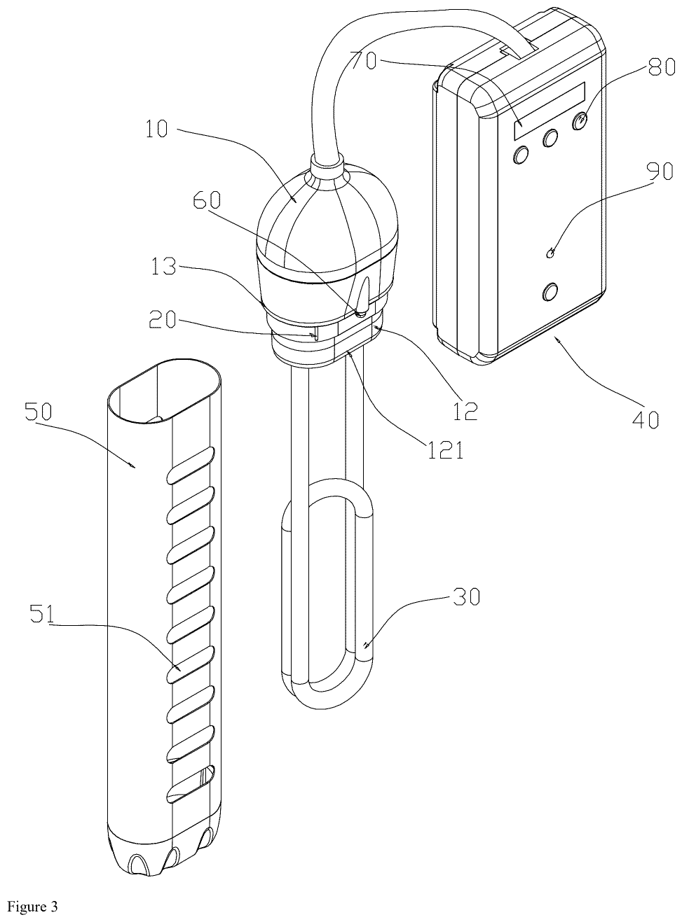

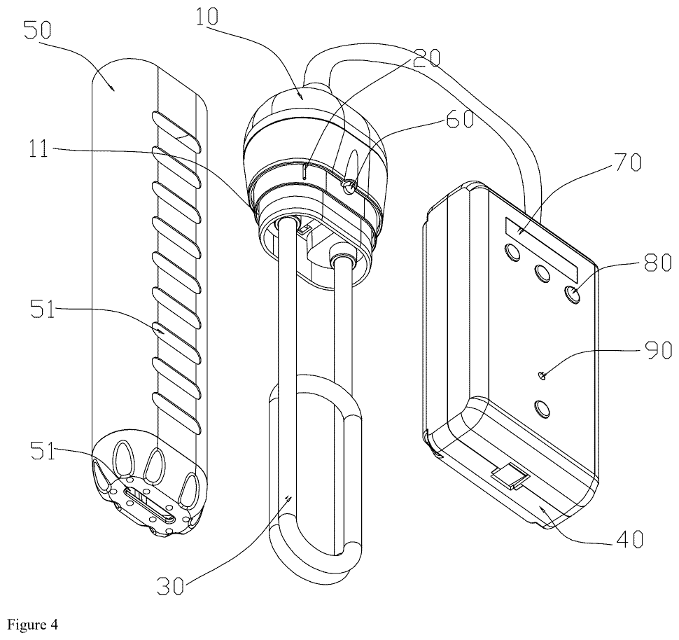

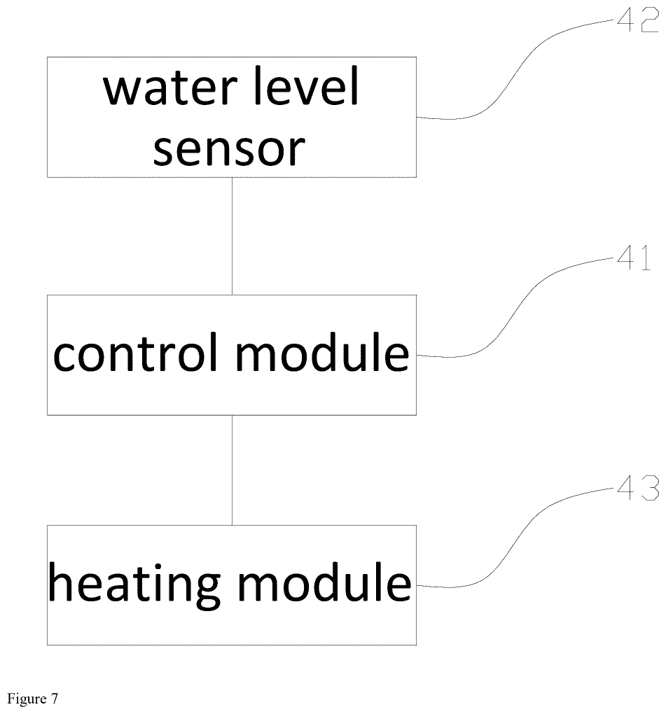

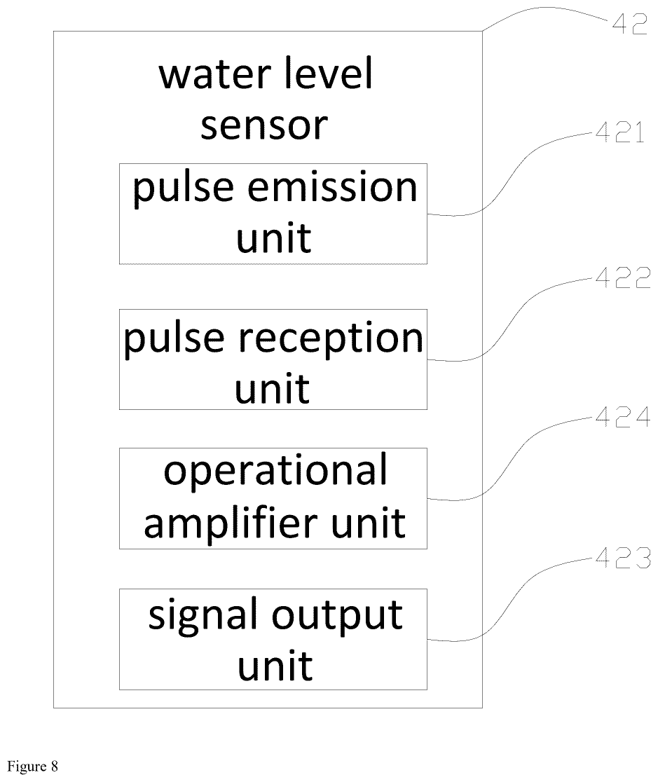

Referring to FIGS. 1 to 12, an immersion water heater includes:

A housing 10, the lower end of which is provided with two probe-type low-water cutoffs 20, the two probe-type low-water cutoffs 20 being respectively located on the front and rear sides of the housing 10;

A water heater 30, the connecting end of which is connected to the lower end of the housing 10, the free end of the water heater 30 extending in a direction away from the housing 10;

A control device 40, which is electrically connected to the water heater 30 and the probe-type low-water cutoffs 20. When both probe-type low-water cutoffs 20 are submerged below the liquid surface, the control device 40 activates the water heater 30. When either of the probe-type low-water cutoffs 20 is out of the liquid surface, the control device 40 deactivates the water heater 30.

With the above-mentioned structural arrangements, when using the product, place it in a water container so that water submerges the water heater 30 and the two probe-type low-water cutoffs 20. Turn on the switch. When both probe-type low-water cutoffs 20 are below the liquid surface, the control device 40 activates the water heater 30, which can quickly heat the water for the user's convenience. However, when the product is tilted or the liquid level drops, and at least one of the two probe-type low-water cutoffs 20 is out of the liquid surface, the control device 40 deactivates the water heater 30 to prevent it from dry burning, thereby extending the product's lifespan, avoiding the risk of fire, and ensuring user safety. Moreover, since the two probe-type low-water cutoffs 20 are located on the front and rear sides of the housing 10, when the product is tilted and placed in the water container, if both probe-type low-water cutoffs 20 are below the liquid surface, it can ensure that the water heater 30 is below the liquid surface. Preferably, there can be three or more probe-type low-water cutoffs 20. When any one of the probe-type low-water cutoffs 20 is out of the liquid surface, the control device 40 deactivates the water heater 30. The probe-type low-water cutoffs 20 are evenly distributed at the lower end of the housing. When all the probe-type low-water cutoffs 20 are below the liquid surface, it can ensure that the water heater 30 is basically below the liquid surface to prevent dry burning.

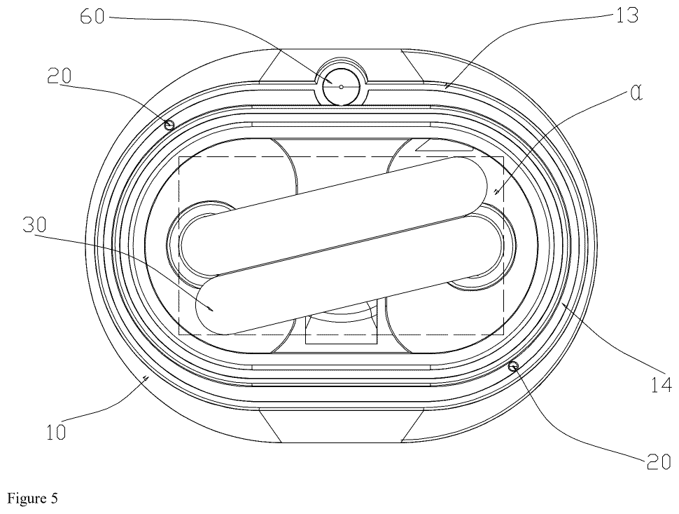

In this embodiment, the water heater 30 has a front surface, a rear surface, a left surface, and a right surface. The front surface passes through the front end of the water heater 30 and is parallel to the front reference plane. The rear surface passes through the rear end of the water heater 30 and is parallel to the front reference plane. The left surface passes through the left end of the water heater 30 and is parallel to the right reference plane. The right surface passes through the right end of the water heater 30 and is parallel to the right reference plane. A heating area a is formed between the front surface, the rear surface, the left surface, and the right surface. The probe-type low-water cutoffs 20 are located outside the heating area a. With the above-mentioned structural arrangements, as shown in FIG. 5, during use, since the probe-type low-water cutoffs 20 are outside the heating area a, when both probe-type low-water cutoffs 20 are below the liquid surface, it can ensure that the water heater 30 is basically below the liquid surface, preventing dry burning, extending the product's lifespan, and preventing scalding of the user or causing a fire, making the product safer to use.

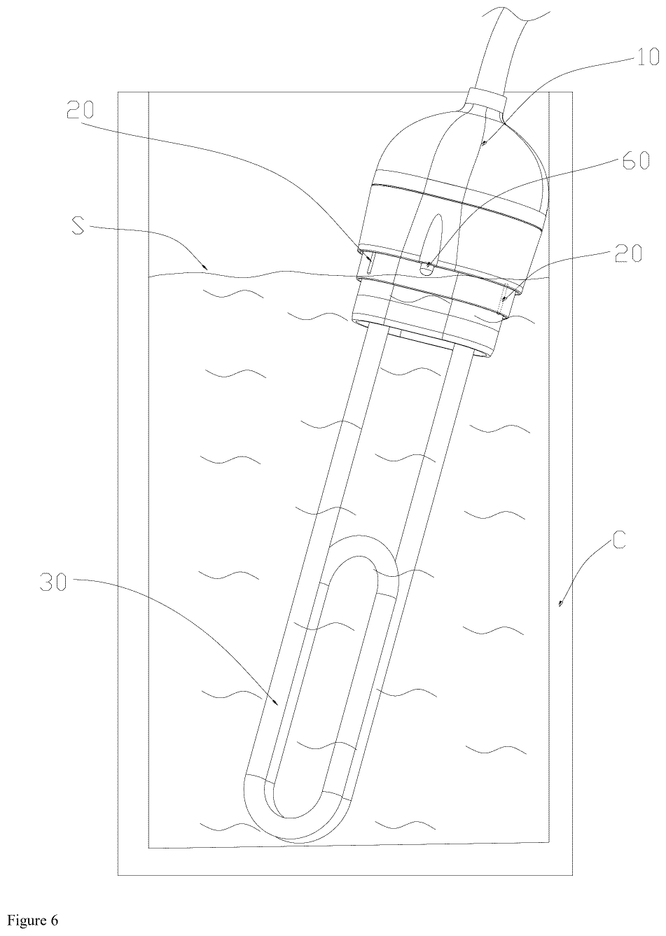

In this embodiment, one probe-type low-water cutoff 20 is located in front of the front surface and to the left of the left surface, and the other probe-type low-water cutoff 20 is located behind the rear surface and to the right of the right surface; or one probe-type low-water cutoff 20 is located in front of the front surface and to the right of the right surface, and the other probe-type low-water cutoff 20 is located behind the rear surface and to the left of the left surface. With the above-mentioned structural arrangements, the two probe-type low-water cutoffs 20 are located at two opposite corners of the heating area a. When the product is tilted towards the front, rear, left, or right side, the horizontal plane of the upper probe-type low-water cutoff 20 is always above the water heater 30. Therefore, when both probe-type low-water cutoffs 20 are below the liquid surface, it can ensure that the water heater 30 is basically below the liquid surface, preventing the water heater 30 from dry burning and avoiding the risk of fire, as well as extending the product's lifespan. As shown in FIG. 6, when the product is placed in a container C, at this time, the liquid surface S submerges one probe-type low-water cutoff 20, while the other probe-type low-water cutoff 20 is just out of the liquid surface S. At this time, the control device 40 deactivates the water heater 30, while the water heater 30 is still below the liquid surface S, preventing dry burning and ensuring user safety and preventing fire.

In this embodiment, the two probe-type low-water cutoffs 20 are respectively an emitting probe and a receiving probe. The emitting probe is used to emit a pulse signal, and the receiving probe is used to receive the pulse signal. When both probe-type low-water cutoffs 20 are submerged below the liquid surface, the receiving probe receives the pulse signal, and the control device 40 activates the water heater 30. When either of the probe-type low-water cutoffs 20 is out of the liquid surface, the receiving probe cannot receive the pulse signal, and the control device 40 deactivates the water heater 30. With the above-mentioned structural arrangements, during use, the emitting probe emits a pulse signal. When both the emitting probe and the receiving probe are below the liquid surface, the pulse signal is transmitted through the water to the receiving probe. The receiving probe receives the pulse signal, and at this time, the control device 40 activates the water heater 30, allowing the product to quickly heat the water. However, when either the emitting probe or the receiving probe is above the liquid surface, the receiving probe cannot receive the pulse signal, and the control device 40 deactivates the water heater 30.

In this embodiment, the control device 40 includes a control module 41, a water level sensor 42, and a heating module 43. The water level sensor 42 and the heating module 43 are electrically connected to the control module 41. When both probe-type low-water cutoffs 20 are submerged below the liquid surface, the water level sensor 42 sends a first signal to the control module 41, and the control module 41 controls the heating module 43 to connect the circuit of the water heater 30. When either of the probe-type low-water cutoffs 20 is out of the liquid surface, the water level sensor 42 sends a second signal to the control module 41, and the control module 41 controls the heating module 43 to disconnect the circuit of the water heater 30.

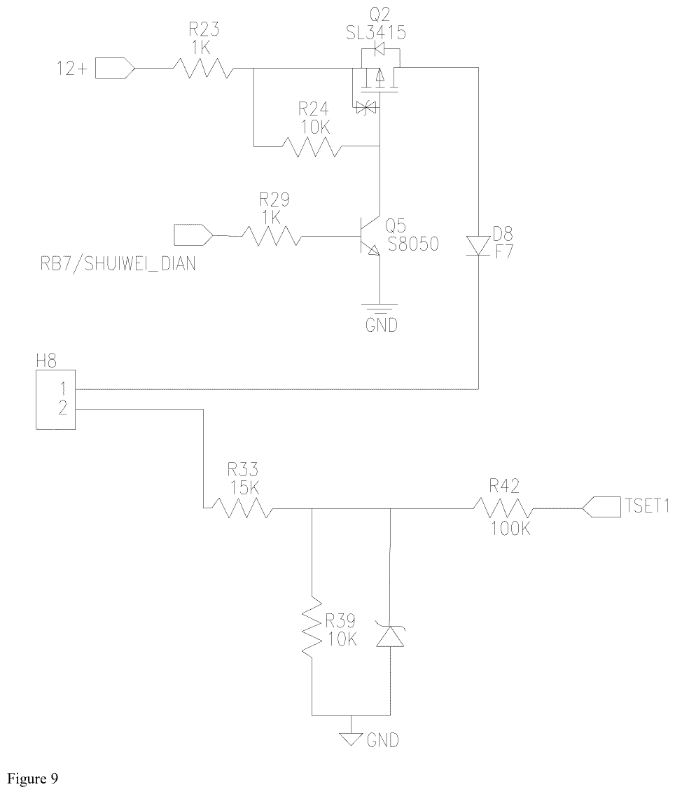

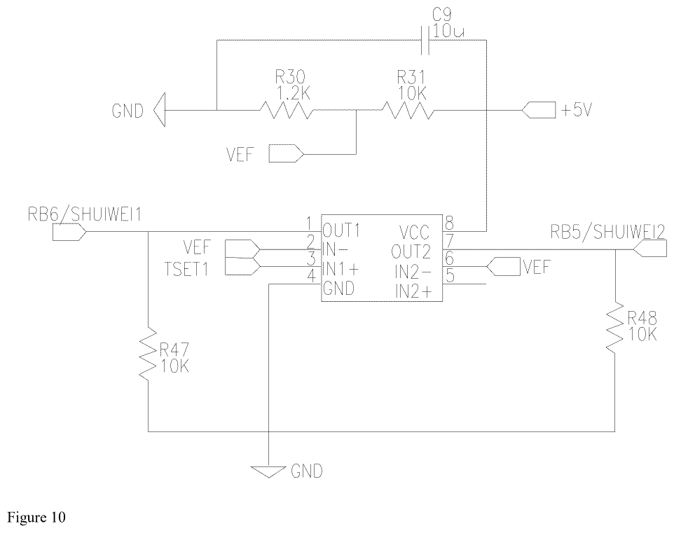

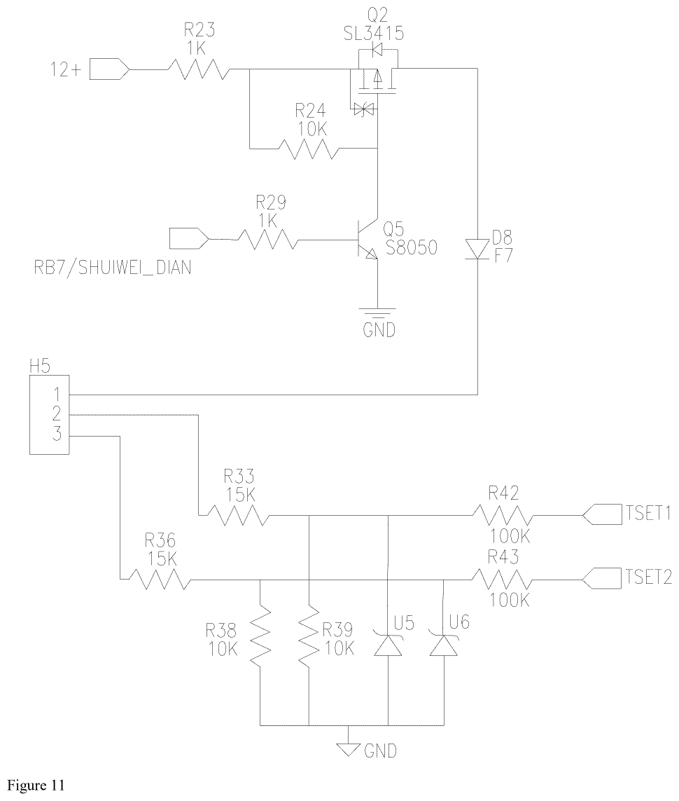

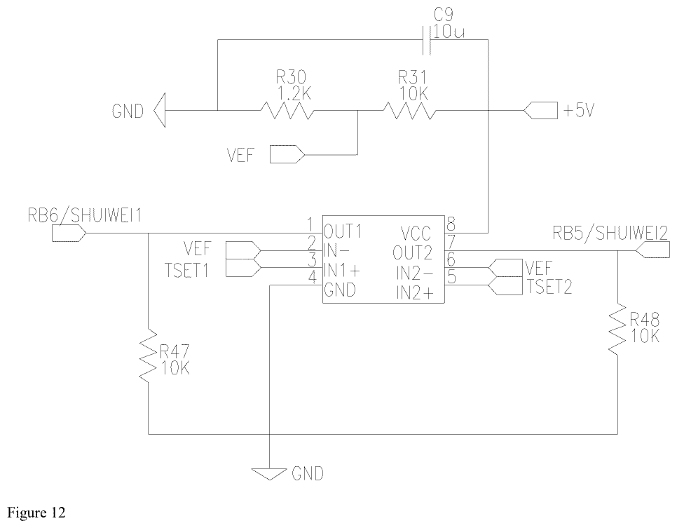

In this embodiment, the water level sensor 42 includes a pulse emission unit 421, a pulse reception unit 422, and a signal output unit 423. The pulse emission unit 421 emits a pulse signal through the emitting probe. The TSET1 pin of the pulse reception unit 422 is electrically connected to the TSET1 pin of the signal output unit 423. The signal output unit 423 outputs the first signal to the control module 41 through the RB6/SHUIWEI1 pin and outputs the second signal to the control module 41 through the RB5/SHUIWEI2 pin, as shown in FIGS. 9 and 10. In the second embodiment, the TSET1 pin of the pulse reception unit 422 is also electrically connected to the TSET2 pin of the signal output unit 423, as shown in FIGS. 11 and 12.

In this embodiment, the water level sensor 42 further includes an operational amplifier unit 424 that is electrically connected to the signal output unit 423, with the VEF pin of the operational amplifier unit 424 being electrically connected to the VEF pin of the signal output unit 423. During use, the operational amplifier unit 424 amplifies the pulse signal received by the pulse reception unit, allowing the signal output unit 423 to stably detect whether the pulse signal is received, preventing misjudgment and enhancing the stability and accuracy of detection.

In this embodiment, a protective cover 50 is also included. The protective cover 50 is connected to the lower end of the housing 10 and covers the water heater 30. The protective cover 50 is provided with a plurality of through holes 51 to allow liquid to pass through. With the above-mentioned structural arrangements, the protective cover 50 covering the water heater 30 can protect the water heater 30 from damage and prevent it from directly contacting the water container or the user, thus avoiding scalding. Meanwhile, the through holes 51 on the protective cover 50 allow water to pass through, facilitating heat exchange during heating and improving the heating rate.

In this embodiment, the lower end of the housing 10 is provided with a connection slot 11, into which the edge of the protective cover 50 is inserted. With the above-mentioned structural arrangements, during assembly, the edge of the protective cover 50 is inserted into the connection slot 11, making installation convenient. Moreover, the recess can hide the edge of the protective cover 50, preventing it from scratching the user.

In this embodiment, at least part of the through holes 51 are located on the lower surface of the protective cover 50. With the above-mentioned structural arrangements, the through holes 51 on the lower surface of the protective cover 50 allow any residual water inside the protective cover 50 to drain out when the product is lifted by the user, keeping the product dry when not in use and extending its lifespan.

In this embodiment, the housing 10 is further provided with a temperature sensor 60 that is electrically connected to the control device 40. The temperature sensor 60 is used to detect the liquid temperature. With the above-mentioned structural arrangements, during use, the temperature sensor 60 can detect the water temperature and feed the data back to the control module 41. The control module 41 then controls the activation or deactivation of the water heater 30, thereby controlling the water temperature for the user's convenience.

In this embodiment, the control device 40 is also electrically connected to a display screen 70, which is used to display the liquid temperature value detected by the temperature sensor 60. With the above-mentioned structural arrangements, the display screen 70, connected to the control device 40, can show various items such as water temperature, heating time, and power connection status, allowing users to intuitively understand the product's operating condition.

In this embodiment, the protective cover 50 is cylindrical, and the projections of both the protective cover 50 and the housing 10 on the top reference plane are oval. With the above-mentioned structural arrangements, the flat-shaped protective cover 50 and housing 10 ensure that when the product is placed in a water container, it is more likely to tilt towards the front or rear side. This ensures that when both probe-type low-water cutoffs are below the liquid surface, the water heater 30 is basically below the liquid surface, thereby preventing dry burning and enhancing the product's safety.

In this embodiment, the control device 40 is also provided with a control button 80, which allows users to output control signals to the control device by pressing the control button. With the above-mentioned structural arrangements, during use, users can press the control button 80 to achieve human-machine interaction; for example, they can press the button to set the heating temperature, heating time, and other data.

In this embodiment, the water heater 30 is a metal column, both ends of which are connected to the lower end of the housing 10. The middle part of the metal column is bent and folded to form a free end in the shape of an oval. With the above-mentioned structural arrangements, bending the middle part of the metal column can increase the surface area of the metal column at the bottom of the product, thereby improving the heating efficiency at this location.

In this embodiment, the duty cycle of the pulse signal emitted by the emitting probe is 1%. During use, the emitting probe emits a pulse signal with a duty cycle of 1%, which significantly reduces the time the circuit from the emitting probe-water-receiving probe is conductive. This prevents the emitting and receiving probes from rusting in the water, ensuring the stability of the detection results while also guaranteeing the product's lifespan. Moreover, the emitting probe sends out a pulse signal every 0.3 seconds. The short time interval allows for a quick and accurate determination of whether both the emitting and receiving probes are underwater. This ensures that the circuit of the water heater 30 is promptly disconnected when either probe emerges from the water, preventing dry burning and avoiding the risk of fire. It also ensures user safety and prolongs the product's lifespan, providing a better user experience.

In this embodiment, the lower end of the housing 10 has a downwardly extending insertion part 12, which is inserted into the opening of the protective cover 50. With the above-mentioned structural arrangements, the insertion part 12 is inserted into the opening of the protective cover 50, allowing the insertion part to support the inner surface of the protective cover. This prevents the protective cover 50 from detaching from the housing 10 when subjected to impact. It also increases the contact area between the insertion part 12 and the inner surface of the protective cover 50, enhancing the stability of the product.

In this embodiment, the outer edge of the end of the insertion part 12 is provided with a guide bevel 121. With the above-mentioned structural arrangements, the guide bevel 121 facilitates the assembly of the product, allowing the insertion part 12 to be more easily inserted into the opening of the protective cover 50, thereby improving the assembly efficiency of the product.

In this embodiment, the housing 10 is also provided with a protective part 13. A protective slot 14 is formed between the protective part 13 and the outer surface of the housing 10, within which at least part of the probe-type low-water cutoffs 20 is located. With the above-mentioned structural arrangements, the protective part 13, shaped like a skirt, forms a protective slot 14 between its inner surface and the outer surface of the housing 10. The connection end of the probe-type low-water cutoffs 20 is situated within the protective slot 14, providing protection for the probe-type low-water cutoffs 20 and making the product structure more stable.

In this embodiment, the control device 40 is also provided with an indicator light 90, which is used to display the working state of the product. With the above-mentioned structural arrangements, during use, users can understand the product's connection status with the power source through the indicator light 90, facilitating the use of the product.

1. An immersion water heater, characterized in that it comprises:
A housing (10), the lower end of which is provided with two probe-type low-water cutoffs (20), the two probe-type low-water cutoffs (20) being respectively located on the front and rear sides of the housing (10);
A water heater (30), the connecting end of which is connected to the lower end of the housing (10), the free end of the water heater (30) extending in a direction away from the housing (10);
The control device (40) is electrically connected to the water heater (30) and the probe-type low-water cutoffs (20). When both probe-type low-water cutoffs (20) are submerged below the liquid surface, the control device (40) activates the water heater (30). When either of the probe-type low-water cutoffs (20) is out of the liquid surface, the control device (40) deactivates the water heater (30).

2. The immersion water heater according to claim 1, characterized in that the water heater (30) comprises a front surface, a rear surface, a left surface, and a right surface. The front surface passes through the front end of the water heater (30) and is parallel to the front reference plane. The rear surface passes through the rear end of the water heater (30) and is parallel to the front reference plane. The left surface passes through the left end of the water heater (30) and is parallel to the right reference plane. The right surface passes through the right end of the water heater (30) and is parallel to the right reference plane. A heating area a is formed between the front surface, the rear surface, the left surface, and the right surface. The probe-type low-water cutoff (20) is located outside the water heater (30).

3. The immersion water heater according to claim 2, characterized in that one probe-type low-water cutoff (20) is located in front of the front surface and to the left of the left surface, and the other probe-type low-water cutoff (20) is located behind the rear surface and to the right of the right surface; or one probe-type low-water cutoff (20) is located in front of the front surface and to the right of the right surface, and the other probe-type low-water cutoff (20) is located behind the rear surface and to the left of the left surface.

4. The immersion water heater according to claim 1, characterized in that the two probe-type low-water cutoffs (20) are respectively an emitting probe and a receiving probe. The emitting probe is used to emit a pulse signal, and the receiving probe is used to receive a pulse signal. When both probe-type low-water cutoffs (20) are submerged below the liquid surface and the receiving probe receives the pulse signal, the control device (40) activates the water heater (30). When either of the probe-type low-water cutoffs (20) is out of the liquid surface and the receiving probe fails to receive the pulse signal, the control device (40) deactivates the water heater (30).

5. The immersion water heater according to claim 4, characterized in that the control device (40) comprises a control module (41), a water level sensor (42), and a heating module (43). The water level sensor (42) and the heating module (43) are electrically connected to the control module (41). When both probe-type low-water cutoffs (20) are submerged below the liquid surface, the water level sensor (42) sends a first signal to the control module (41), and the control module (41) controls the heating module (43) to connect the circuit of the water heater (30). When either of the probe-type low-water cutoffs (20) is out of the liquid surface, the water level sensor (42) sends a second signal to the control module (41), and the control module (41) controls the heating module (43) to disconnect the circuit of the water heater (30).

6. The immersion water heater according to claim 5, characterized in that the water level sensor (42) comprises a pulse emission unit (421), a pulse reception unit (422), and a signal output unit (423). The pulse emission unit (421) emits a pulse signal through the emitting probe. The TSET1 pin of the pulse reception unit (422) is electrically connected to the TSET1 pin of the signal output unit (423). The signal output unit (423) outputs the first signal to the control module (41) through the RB6/SHUIWEI1 pin and outputs the second signal to the control module (41) through the RB5/SHUIWEI2 pin.

7. The immersion water heater according to claim 6, characterized in that the water level sensor (42) further comprises an operational amplifier unit (424) that is electrically connected to the signal output unit (423), with the VEF pin of the operational amplifier unit (424) being electrically connected to the VEF pin of the signal output unit (423).

8. The immersion water heater according to claim 1, characterized in that it further comprises a protective cover (50) that is connected to the lower end of the housing (10) and covers the water heater (30). The protective cover (50) is provided with a plurality of through holes (51) to allow liquid to pass through.

9. The immersion water heater according to claim 8, characterized in that the lower end of the housing (10) is provided with a connection slot (11), into which the edge of the protective cover (50) is inserted.

10. The immersion water heater according to claim 1, characterized in that at least part of the through holes (51) are located on the lower surface of the protective cover (50).

11. The immersion water heater according to claim 1, characterized in that the housing (10) is further provided with a temperature sensor (60) that is electrically connected to the control device (40). The temperature sensor (60) is used to detect the liquid temperature.

12. The immersion water heater according to claim 11, characterized in that the control device (40) is further electrically connected to a display screen (70). The display screen (70) is used to display the liquid temperature value detected by the temperature sensor (60).

13. The immersion water heater according to claim 8, characterized in that the protective cover (50) is cylindrical, and the projections of the protective cover (50) and the housing (10) on the top reference plane are both oval.

14. The immersion water heater according to claim 1, characterized in that the control device (40) further comprises a control button (80) that is used to allow the user to output a control signal to the control device by pressing the control button.

15. The immersion water heater according to claim 1, characterized in that the water heater (30) is a metal column, both ends of the metal column being connected to the lower end of the housing (10), the middle part of the metal column being bent and folded to form a free end in the shape of an oval.

16. The immersion water heater according to claim 4, characterized in that the duty cycle of the pulse signal emitted by the emitting probe is 1%.

17. The immersion water heater according to claim 8, characterized in that the lower end of the housing (10) has a downwardly extending insertion part (12), the insertion part (12) being inserted into the opening of the protective cover (50).

18. The immersion water heater according to claim 17, characterized in that the outer edge of the end of the insertion part (12) is provided with a guide bevel (121).

19. The immersion water heater according to claim 1, characterized in that the housing (10) is further provided with a protective part (13), a protective slot (14) being formed between the protective part (13) and the outer surface of the housing (10), at least part of the probe-type low-water cutoffs (20) being located within the protective slot (14).

20. The immersion water heater according to claim 1, characterized in that the control device (40) further comprises an indicator light (90), the indicator light (90) being used to display the working state of the product.
